(19) United States
(12) Patent Application Publication
(10) Pub. No.: US 2006/0163988 A1
(43) Pub. Date: Jul. 27, 2006

(54) Backlight assembly, method of manufacturing the same and liquid crystal display apparatus having the same

(76) Inventors: Seock-Hwan Kang, Suwon-si (KR); Hye-Eun Park, Suwon-si (KR); Sang-Yu Lee, Yongin-si (KR); In-Sun Hwang, Suwon-si (KR); Joong-Hyun Kim, Suwon-si (KR)

Correspondence Address: CANTOR COLBURN, LLP, 55 GRIFFIN ROAD SOUTH, BLOOMFIELD, CT, 06002, US

(21) Appl. No.: 11/338,920

(22) Filed: Jan. 25, 2006

(30) Foreign Application Priority Data
Jan. 25, 2005 (KR) 2005-6579

(51) Int. Cl. H01K 1/30; H01J 61/40; H01J 5/16

(52) U.S. Cl. 313/110; 313/112

(57) ABSTRACT

A backlight assembly includes a receiving container having a receiving space, a flat-type light source, an optical member, and an inverter. The flat-type light source has a plurality of light emitting spaces spaced apart from each other and is received into the receiving space. The optical member has a prism pattern formed in areas corresponding to areas between adjacent light emitting spaces and disposed at a light emitting direction of the flat-type light source. The inverter generates a voltage for the flat-type light source. The prism pattern 1o includes prisms having a substantially trigonal prism and continuously connected one after another. Thus, the backlight assembly may improve brightness uniformity thereof and have a reduced thickness.

This application claims priority to Korean Patent Application No. 2005-6579, filed on Jan. 25, 2005 and all the benefits accruing therefrom under 35 U.S.C. §119, and the contents of which in its entirety are herein incorporated by reference.

### BACKGROUND OF THE INVENTION

1. Field of the Invention

The present invention relates to a backlight assembly, a method of manufacturing the backlight assembly, and a liquid crystal display (“LCD”) apparatus having the backlight assembly. More particularly, the present invention relates to a backlight assembly having enhanced brightness and reduced thickness, a method of manufacturing the backlight assembly, and an LCD apparatus having the same.

2. Description of the Related Art

In general, a liquid crystal display (“LCD”) apparatus displays an image using optical and electrical properties of liquid crystal, such as an anisotropic refractive index and an anisotropic dielectric constant. The LCD apparatus has characteristics, such as, for example, a lighter weight structure, a lower power consumption, a lower driving voltage, etc., in comparison with a display apparatus such as a cathode ray tube (“CRT”), and a plasma display panel (“PDP”).

The LCD apparatus requires a backlight assembly since the LCD panel is not self-emissive. A tubular-shaped cold cathode fluorescent lamp (“CCFL”) is often used for the light source of the LCD apparatus. However, in a large-scaled LCD apparatus, a quantity of the CCFL and manufacturing cost increase, so that optical properties such as brightness uniformity, etc., are deteriorated.

Recently, in order to reduce the manufacturing cost and enhance the brightness uniformity of an LCD apparatus, a flat-type fluorescent lamp emitting a planar light has been developed. The flat-type fluorescent lamp includes a plurality of light emitting spaces so as to uniformly emit a light from an upper surface thereof. When a voltage from an inverter is applied to an electrode thereof, a plasma discharge is generated in each of the light emitting spaces. A fluorescent layer inside the flat-type fluorescent lamp is excited in response to an ultraviolet light caused by the plasma discharge to generate a visible light.

In order to efficiently emit the light, since the flat-type fluorescent lamp has an inner space divided into the plurality of light emitting spaces, a dark line portion occurs on an LCD panel corresponding to positions between the adjacent light emitting spaces. A conventional backlight assembly further includes a diffusion plate such that the dark line portion is removed. The diffusion plate is disposed above a light exiting surface of the flat-type fluorescent lamp. However, the diffusion plate is spaced apart from the light exit surface by a distance of about 12 mm. As a result, light loss of the LCD apparatus increases, and a thickness of the backlight assembly also deleteriously increases.

### BRIEF SUMMARY OF THE INVENTION

The present invention provides a backlight assembly having enhanced brightness and reduced thickness.

The present invention also provides a manufacturing method suitable for the above backlight assembly.

The present invention also provides an LCD apparatus having the above backlight assembly.

In exemplary embodiments of the present invention, a backlight assembly includes a receiving container having a receiving space, a flat-type light source, an optical member, and an inverter. The flat-type light source has a plurality of light emitting spaces spaced apart from each other and received within the receiving space. The optical member has a prism pattern formed in areas corresponding to areas between adjacent light emitting spaces and is disposed at the light emitting direction of the flat-type light source. The inverter generates a voltage for the flat-type light source. The prism pattern includes prisms having a substantially trigonal prism and continuously connected one after another.

In other exemplary embodiments of the present invention, a backlight assembly includes a receiving container to provide a receiving space, a flat-type fluorescent lamp, a diffusion plate, and an inverter. The flat-type fluorescent lamp has a plurality of light emitting spaces spaced apart from each other to emit a light and is received into the receiving space. The diffusion plate has a prism pattern formed in areas corresponding to areas between adjacent light emitting spaces and is disposed on the flat-type fluorescent lamp. The inverter generates a voltage for the flat-type fluorescent lamp. The prism pattern includes prisms having a substantially trigonal prism and continuously connected one after another.

In still other exemplary embodiments of the present invention, in accordance with a manufacturing method of a backlight assembly, a flat-type fluorescent lamp having a plurality of light emitting spaces spaced apart from each other to emit a light is received within a receiving container. An optical member having a prism pattern formed in areas corresponding to areas between adjacent light emitting spaces is disposed on the flat-type fluorescent lamp. An inverter is coupled to the receiving container. The inverter is configured to generate a voltage for the fiat-type fluorescent lamp.

In further still other exemplary embodiments of the present invention, a liquid crystal display apparatus includes a backlight assembly and a display unit. The backlight assembly includes a receiving container having a receiving space, a flat-type fluorescent lamp, an optical member, and an inverter. The flat-type fluorescent lamp has a plurality of light emitting spaces spaced apart from each other to emit a light and is received within the receiving space. The optical member has a prism pattern formed in areas corresponding to areas between the light emitting spaces and is disposed on the flat-type fluorescent lamp. The inverter generates a voltage for the flat-type fluorescent lamp. The display unit displays an image using the light from the backlight assembly.

According to the above, the backlight assembly includes the optical member having the prism pattern formed at areas corresponding to areas between adjacent light emitting spaces or the diffusion plate having the prism pattern formed on the lower face thereof, so that the backlight assembly may improve the brightness uniformity. Also, the backlight assembly may have a reduced thickness since the distance between the optical member or the diffusion plate and the flat-type fluorescent lamp is reduced.

### BRIEF DESCRIPTION OF THE DRAWINGS

The above and other advantages of the present invention will become readily apparent by reference to the following detailed description when considered in conjunction with the accompanying drawings wherein:

FIG. 1 is an exploded perspective view showing an exemplary embodiment of a backlight assembly according to the present invention;

FIG. 2 is a cross-sectional view showing an exemplary flat-type fluorescent lamp, an exemplary optical member, and an exemplary diffusion plate in FIG. 1;

FIG. 3 is an enlarged cross-sectional view of an exemplary prism pattern shown in FIG. 2;

FIG. 4 is a cross-sectional view of another exemplary embodiment of an optical member according to the present invention;

FIG. 5 is a cross-sectional view showing another exemplary embodiment of an optical member according to the present invention;

FIG. 6 is a perspective view showing the exemplary flat-type fluorescent lamp in FIG. 1;

FIG. 7 is a cross-sectional view taken along line I-I′ showing the exemplary flat-type fluorescent lamp in FIG. 6;

FIG. 8 is an exploded perspective view showing another exemplary embodiment of a backlight assembly according to the present invention;

FIG. 9 is a cross-sectional view of an exemplary flat-type fluorescent lamp and an exemplary diffusion plate shown in FIG. 8, and

FIG. 10 is an exploded perspective view showing an exemplary embodiment of an LCD apparatus according to the present invention.

### DETAILED DESCRIPTION OF THE INVENTION

Hereinafter, the present invention will be explained in detail with reference to the accompanying drawings. In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

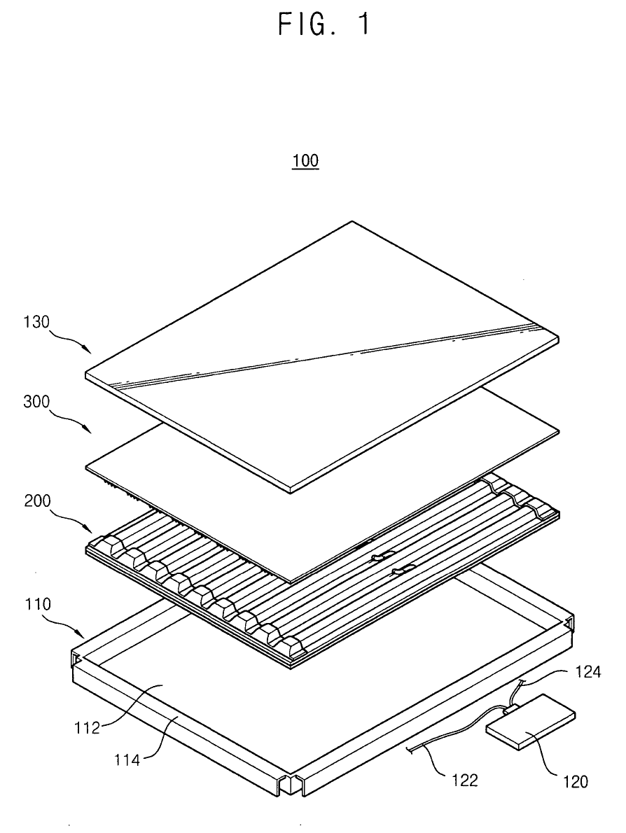

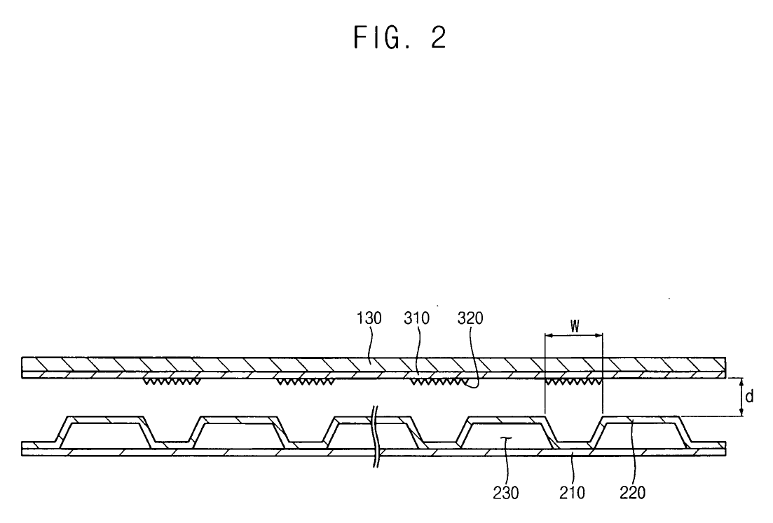

FIG. 1 is an exploded perspective view showing an exemplary embodiment of a backlight assembly according to the present invention. FIG. 2 is a cross-sectional view showing an exemplary flat-type fluorescent lamp, an exemplary optical member, and an exemplary diffusion plate in FIG. 1.

Referring to FIGS. 1 and 2, a backlight assembly 100 includes a receiving container 110, a flat-type fluorescent lamp 200, an optical member 300, and an inverter 120.

The receiving container 110 includes a bottom portion 112 and a side portion 114 extended from the bottom portion 112 to provide a receiving space for the flat-type fluorescent lamp 200. The bottom portion 112 may be substantially rectangular shaped, or otherwise shaped in a size to accommodate the flat-type fluorescent lamp 200. In a rectangular-shaped embodiment, the bottom portion 112 includes first, second, third, and fourth sides, with first and third sides parallel to each other, second and fourth sides parallel to each other, and the first and third sides perpendicular to the second and fourth sides. The side portion 114 may include first through fourth side portion sections, where each side portion section extends from a respective side of the bottom portion 112. The side portion 114 is bent over two times in order to provide coupling space and coupling strength for other elements (not shown) of an LCD apparatus. In other words, the side portion 114 may have the cross-sectional shape of an upside-down U. The receiving container 110 includes a metal material, or other suitable material, having a superior strength to avoid deformation thereof.

The flat-type fluorescent lamp 200 is received into the receiving space of the receiving container 110 defined by the bottom portion 112 and side portion 114. The flat-type fluorescent lamp 200 is divided into a plurality of light emitting spaces 230 so as to emit a light. The light emitting spaces 230 each have a longitudinal axis substantially parallel to the longitudinal axes of other light emitting spaces 230, and the longitudinal axes of the light emitting spaces 230 extend substantially parallel to first and third sides of the flat-type fluorescent lamp 200, and substantially perpendicular to second and fourth sides of the flat-type fluorescent lamp 200. The light emitting spaces 230 are spaced apart from each other by a predetermined distance. In order to emit the light as a planar light, the flat-type fluorescent lamp 200 in plan view has a substantially rectangular shape with the first, second, third, and fourth sides. The flat-type fluorescent lamp 200 makes a plasma discharge in the light emitting spaces 230 in response to a voltage applied from the inverter 120. The flat-type fluorescent lamp 200 converts ultraviolet lights generated due to the plasma discharge into visible lights and emits the visible lights. The flat-type fluorescent lamp 200 has an inner space divided into the light emitting spaces 230, so that the flat-type fluorescent lamp 200 may improve light emitting efficiency and emit uniform lights. The flat-type fluorescent lamp 200 includes a first substrate 210 and a second substrate 220 coupled to the first substrate 210 to form the light emitting spaces 230. The first substrate 210 may face the bottom portion 112, while the second substrate 220 emits the light toward an LCD panel, as will be further described below. The second substrate 220 includes light emitting -space portions, space-dividing portions, and a sealing portion. The light emitting space portions are spaced apart from the first substrate to form the light emitting spaces 230. The space-dividing portions are disposed between the light emitting space portions and make contact with the first substrate 210 to divide the light emitting spaces 230 from each other. The sealing portion is formed at an end of the second substrate 220 and coupled to the first substrate 210.

In order to reduce a dark line portion visible on an LCD panel corresponding to locations of the space-dividing portions and enhance light efficiency, the optical member 300 is disposed on the flat-type fluorescent lamp 200, such that the flat-type fluorescent lamp 200 is positioned between the bottom portion 112 of the receiving container 110 and the optical member 300. The optical member 300 includes a base film 310 having a lower face facing the flat-type fluorescent lamp 200 and an upper face facing the diffusion plate 130. A prism pattern 320 is formed on the lower face of the base film 310.

The prism pattern 320 is formed on areas corresponding to areas between the light emitting spaces 230. More particularly, the prism pattern 320 is formed on areas of the lower face of the base film 310 that are aligned with the space dividing portions between the light emitting space portions of the second substrate 220. In the present embodiment, the prism pattern 320 has a width (W) of about 6 mm corresponding to the areas between the light emitting spaces 230. The width W may be greater than a width of the space dividing portions, and therefore the prism pattern 320 may overlap portions of the light emitting space portions that are adjacent the space dividing portions. The prism pattern 320 extends in the same direction as the longitudinal axes of the light emitting spaces 230. That is, the base film 310 may have a substantially rectangular shape having first, second, third, and fourth sides corresponding to respective sides of the flat-type fluorescent lamp 200. Each prism pattern 320 may extend perpendicularly from the second side of the base film 310 to the fourth side of the base film 310. Also, a plurality of such prism patterns 320 may be provided on the lower face of the base film 310 and may extend parallel to first and third sides of the base film 310. Other areas of the lower surface of the base film 310 not having the prism patterns 320 are prism absent portions. In other words, the prism absent portion is defined by areas of the optical member not having the prism pattern, wherein the areas of the optical member not having the prism pattern alternate with areas of the optical member having the prism pattern. The prism pattern 320 reflects the lights toward a substantially vertical direction with respect to the base film 310, which are incident into side faces thereof from the light emitting spaces 230. Thus, the prism pattern 320 changes paths of the light from the light emitting spaces 230, to thereby reduce the dark line otherwise visible on an LCD panel and improve brightness uniformity.

The optical member 300 is disposed on the flat-type fluorescent lamp 200 and spaced apart from an upper face of the flat-type fluorescent lamp 200 by a predetermined distance (d), where the upper face of the flat-type fluorescent lamp 200 is defined by a surface of the second substrate 220 positioned furthest from the first substrate 210. The predetermined distance (d) between the optical member 300 and the flat-type fluorescent lamp 200 depends upon a shape of the prism pattern 320, or is below about 10 mm. In the present embodiment, the optical member 300 is spaced apart from the flat-type fluorescent lamp 200 by a distance (d) from about 2 mm to about 4 mm. By reducing the distance (d) between the optical member 300 and the flat-type fluorescent lamp 200, the backlight assembly 100 may have a remarkably reduced overall thickness.

The optical member 300 includes a transparent material such as polycarbonate (“PC”), polyethylene terephthalate (“PET”) or the like to prevent a light loss while the light passes through the optical member 300. The optical member 300 having the prism pattern 320 may be formed in various manners such as stamping, extruding molding, injection molding and so on.

The inverter 120 generates the voltage to drive the flat-type fluorescent lamp 200 for the flat-type fluorescent lamp 200 to emit light. The inverter 120 boosts an alternating current voltage at a low voltage level to output an alternating current voltage at a high voltage level as the voltage. The voltage generated from the inverter 120 is applied to the flat-type fluorescent lamp 200 through a first power line 122 and a second power line 124. The first power line 122 may connect with an upper and lower electrode extending along the second side of the flat-type fluorescent lamp 200, while the second power line 124 may connect with an upper and lower electrode extending along the fourth side of the flat-type fluorescent lamp 200.

The backlight assembly 100 may further include a diffusion plate 130 disposed on the optical member 300. More particularly, while the prism pattern 320 is positioned on a lower face of the base film 310, the diffusion plate 130 may be positioned on an upper face of the base film 310. The diffusion plate 130 diffuses the lights from the optical member 300 to improve the brightness uniformity of the lights. The diffusion plate 130 includes a transparent material such as polymethyl methacrylate (“PMMA”). Also, the diffusion plate 130 may further include a light diffusing agent for the lights.

When the optical member 300 is spaced apart from the flat-type fluorescent lamp 200, the optical member 300 is vulnerable to deformation such as warpage since the optical member 300 has a thin sheet structure. Thus, the optical member 300 may be coupled to a lower face of the diffusion plate 130 to prevent the deformation thereof. That is, the upper face of the base film 310 may be coupled to the lower face of the diffusion plate 130. In the present embodiment, the optical member 300 may be coupled to the lower face of the diffusion plate 130 using a transparent adhesive. Although not shown in FIGS. 1 and 2, in order to improve brightness characteristics of the lights, the backlight assembly 100 may further include various optical sheets, such as, for example, a diffusion sheet, a prism sheet and so on.

FIG. 3 is an enlarged cross-sectional view of an exemplary prism pattern shown in FIG. 2.

Referring to FIG. 3, the prism pattern 320 is formed on the lower face of the base film 310. The prism pattern 320 includes prisms 330 continuously connected one after another to each other. The prisms 330 have a substantially trigonal prism.

Each of the prisms 330 is protruded from the lower face of the base film 310, and includes a first inclined face 332 and a second inclined face 334. In the present embodiment, the prisms 330 have an identical shape to each other. That is, each of the prisms 330 has the same internal angle θ between the first inclined face 332 and the second inclined face 334. The internal angle θ between the first and second inclined faces 332 and 334 is determined such that the lights passing non-perpendicularly from the light emitting spaces 230 and through the prisms 330 vertically exit with respect to the lower face of the base film 310. That is, the light will change direction from being non-perpendicular with respect to the lower face of the base film 310 to perpendicular with respect to the lower face of the base film 310. For example, when the distance (d) between the flat-type fluorescent lamp 200 and the optical member 300 is about 2 mm, an incident light amount of the lights is substantially greatest at an angle of about 30 degrees with respect to a horizontal reference plane. Thus, in order to reflect the lights having an incident angle of about 30 degrees to a vertical direction, the internal angle θ between the first and second inclined faces 332 and 334 is about 60 degrees. That is, each of the prisms 330 has a regular triangle shape.

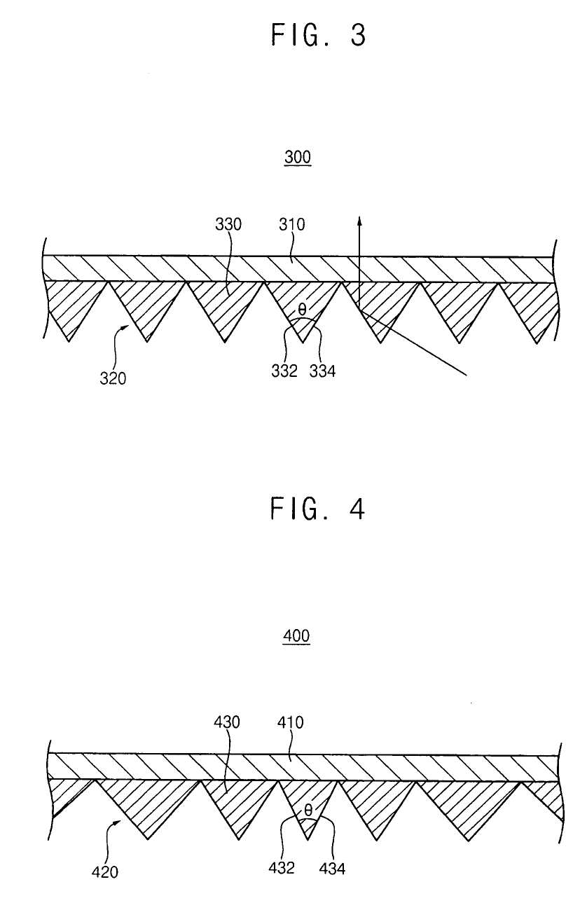

FIG. 4 is a cross-sectional view of another exemplary embodiment of an optical member according to the present invention.

Referring to FIG. 4, an optical member 400 includes a base film 410 and a prism pattern 420 formed on a lower face of the base film 410. The prism pattern 420 is formed on areas corresponding to areas between the light emitting spaces 230, in other words, each prism pattern 420 is aligned with a space dividing portion of the second substrate 220.

The prism pattern 420 includes prisms 430 continuously connected one after another to each other. Each of the prisms 430 is protruded from the lower face of the base film 410, so that each of the prisms 430 includes a first inclined face 432 and a second inclined face 434. In the present embodiment, the prisms 430 do not all have the same internal angle θ between the first inclined face 432 and the second inclined face 434. The internal angle θ between the first and second inclined faces 432 and 434 increases as the prisms 430 are further spaced apart from a center portion of the prism pattern 420. That is, an internal angle θ of a prism positioned at the center portion of the prism pattern 420 is smallest and both outermost prisms at each sides of the prism pattern 420 have an internal angle θ that is greatest, thus pairs of prisms 430 having the same internal angle θ are positioned on opposite sides of the center portion of the prism pattern 420. The prism 430 positioned at the center portion of the prism pattern 420 may be aligned with a center position of the space dividing portion of the second substrate 220.

Alternatively, the prism pattern 420 may have a structure of which the internal angle θ between the first and second inclined faces 432 and 434 decreases accordingly as the prisms 430 are further spaced apart from a center portion of the prism pattern 420. Thus, in this example, the prism 430 positioned at a center portion of the prism pattern 420 would have the greatest internal angle θ, and the internal angle θ of subsequent prisms 430 would gradually decrease on both sides of the prism pattern 420 up to the end of the prism pattern 420. When the prisms 430 have the internal angle a that is gradually increased or decreased from a center portion of the prism pattern 420, the prism pattern 420 may efficiently reflect the lights from the flat-type fluorescent lamp 200.

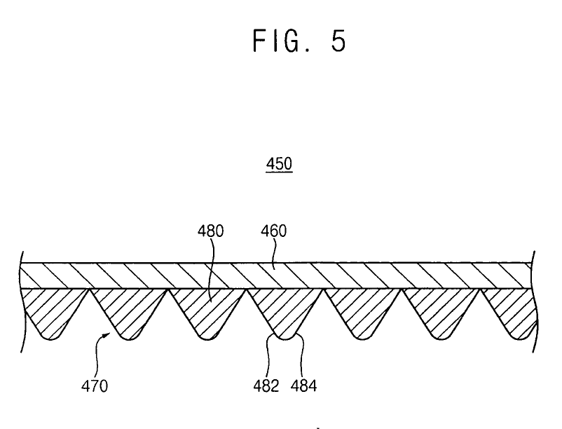

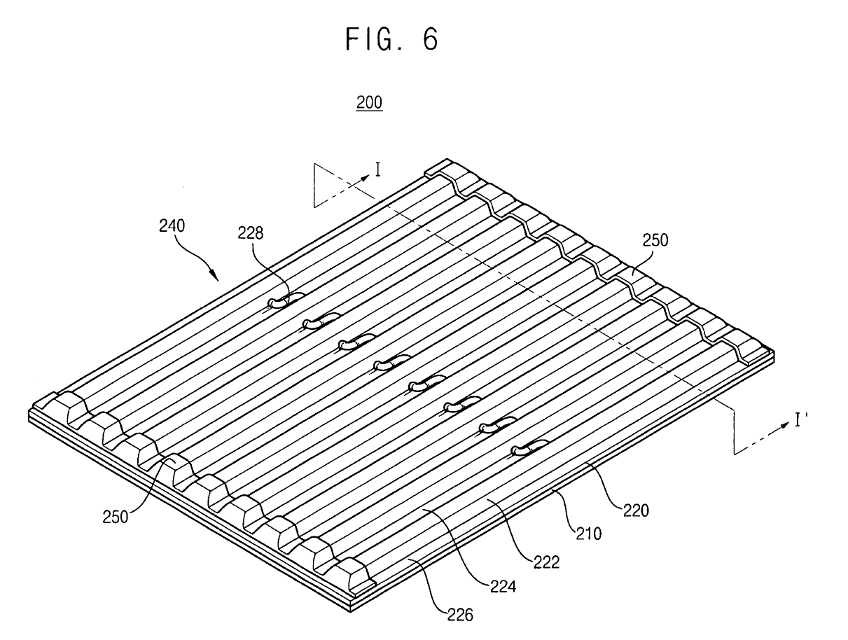

FIG. 5 is a cross-sectional view showing another exemplary embodiment of an optical member according to the present invention.

Referring to FIG. 5, an optical member 450 includes a base film 460 and a prism pattern 470 formed on a lower face of the base film 460. The prism pattern 470 is formed on areas corresponding to areas between the light emitting spaces 230. That is, the prism pattern 470 may be provided on locations of the lower face of the base film 460 that correspond to locations of the space dividing portions on the second substrate 220 of the flat-type fluorescent lamp 200.

The prism pattern 470 includes prisms 480 continuously connected one after another to each other. The prisms 480 have a substantially trigonal prism. Each of the prisms 480 is protruded from the lower face of the base film 460, so that each of the prisms 480 includes a first inclined face 482 and a second inclined face 484. In the present embodiment, each of the prisms 480 has a rounded corner where the first inclined face 482 meets the second inclined face 484. The optical member 450 has same function and structure as those of the optical members 300 and 400 in FIGS. 3 and 4 except for the rounded corner, and thus any further detailed description will be omitted. The internal angle of each of the prisms 480 may either be the same as previously described with respect to FIG. 3, or may alternatively be gradually increased or decreased from a center portion of the prism pattern 470 as previously described with respect to FIG. 4.

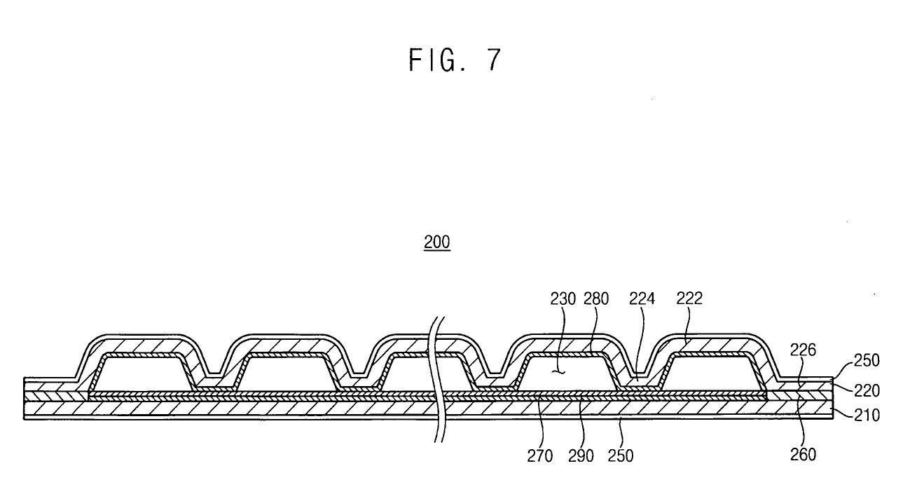

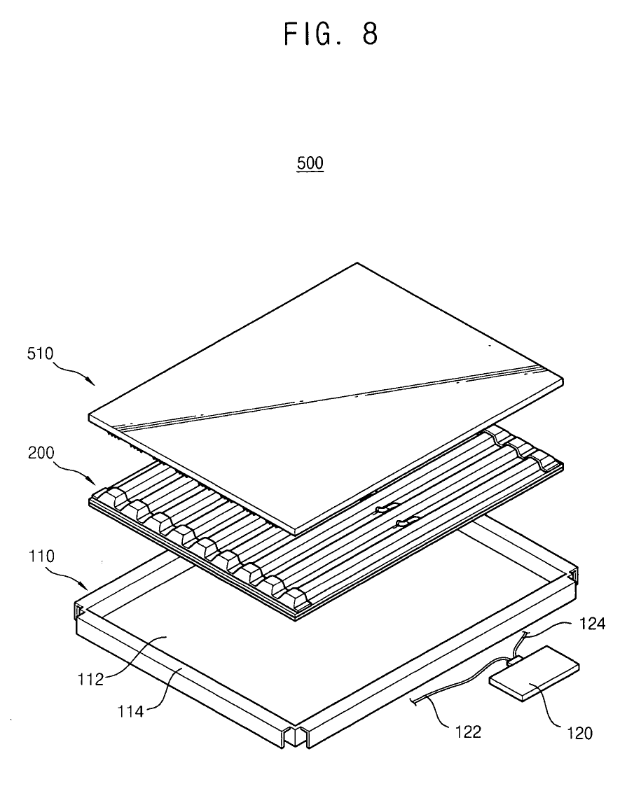

FIG. 6 is a perspective view showing the exemplary flat-type fluorescent lamp in FIG. 1. FIG. 7 is a cross-sectional view taken along line I-I′ showing the exemplary flat-type fluorescent lamp in FIG. 6.

Referring to FIGS. 6 and 7, the flat-type fluorescent lamp 200 includes a lamp body 240 having the light emitting spaces 230 spaced apart from each other and an electrode 250 formed at both ends of the lamp body 240. The electrode 250 is intersected with the light emitting spaces 230. The flat-type fluorescent lamp 200 may have the previously described rectangular shape with the first, second, third, and fourth sides. Thus, the light emitting spaces 230 may be extended in a same direction as the first and third sides, and may be substantially perpendicular to the second and fourth sides. The electrode 250 may be positioned along the second and fourth sides to thus intersect both ends of each light emitting space 230.

The lamp body 240 includes the first substrate 210 and the second substrate 220 to form the light emitting spaces 230.

The first substrate 210 has a plate-like shape positionable within the receiving container 110. The first substrate 210 includes a glass. The first substrate 210 may further include a blocking material to prevent the leakage of the ultraviolet lights from the light emitting spaces 230. Thus, the first substrate 210 includes an upper, inner surface facing the light emitting spaces 230, and a lower, outer surface facing the bottom portion 112 of the receiving container 110.

The second substrate 220 is a substrate molded to form the light emitting spaces 230. The second substrate 220 includes a transparent material such that the visible lights generated in the light emitting spaces 230 passes through the second substrate 220 to the optical member 300. The second substrate 220 also includes the glass. The second substrate 220 may further include a blocking material to prevent the leakage of the ultraviolet lights from the light emitting spaces 230. Thus, the second substrate 220 includes a lower, inner surface facing the light emitting spaces 230, and an upper, outer surface facing the optical member 300.

The second substrate 220 may be formed by various molding process. For example, the second substrate 220 may be formed in such a manner that a glass substrate having a plate-like shape is heated at a predetermined temperature and molded through a mold. Alternatively, the second substrate 220 may be formed in such a manner that heats the glass substrate and injects an air into the heated glass substrate.

In order to form the light emitting spaces 230, the molded second substrate 220 includes light emitting space portions 222, space-dividing portions 224, and a sealing portion 226. The light emitting space portions 222 are spaced apart from the first substrate 210 to form the light emitting spaces 230. The space-dividing portions 224 are disposed between the light emitting space portions 222 and make contact with the first substrate 210 to divide the light emitting spaces 230. The light emitting space portions 222 and the space-dividing portions 224 extend in a direction substantially parallel to the first and third sides of the flat-type fluorescent lamp 200. The sealing portion 226 is formed at an end of the second substrate 220 and coupled to the first substrate 210. The sealing portion 226 may be formed adjacent the first and third sides of the flat-type fluorescent lamp 200, as well as adjacent the second and fourths sides of the flat-type fluorescent lamp 200. In other words, the sealing portion 226 may follow a periphery of the first substrate 210. As illustrated, the second substrate 220 has a cross-sectional profile that includes a plurality of half-arches arranged one after another as shown in FIG. 2. However, the second substrate 220 may be allowed to have various cross-sectional profiles, such as, for example, a semicircle, a square, a trapezoid, etc.

The second substrate 220 has a connection path 228 to connect adjacent light emitting spaces 230 to each other. Each of the light emitting spaces 230 is connected to adjacent light emitting spaces 230 by means of at least one connection path 228. A discharge gas injected into the light emitting spaces 230 may be flowed into other light emitting spaces 230 through the connection path 228 such that the discharge gas may be uniformly distributed into all light emitting spaces 230. Although the connection paths 228 are shown aligned in a central location of the lamp body 240, the connections paths 228 may be positioned in any pattern along the second substrate 220. Also, more than one connection path 228 may be provided between each pair of light emitting space portions 222.

The connection path 228 is substantially and simultaneously formed when the second substrate 220 is formed through the molding process. The connection path 228 may have various shapes such as an “S” shape. When the connection path 228 has the “S” shape, channeling phenomena due to interference between the light emitting spaces 230 may be prevented since a flowing path through which the discharge gas flows is lengthened.

The second substrate 220 is coupled to the first substrate 210 by means of an adhesive 260 such as a frit having a melting point lower than that of a glass. That is, the adhesive 260 is disposed between the first and second substrates 210 and 220 corresponding to the sealing portion 226 of the second substrate 220 and a periphery of the first substrate 210, and then the adhesive 260 is heated, to thereby combine the first substrate 210 with the second substrate 220. In the present embodiment, the combination between the first and second substrates 210 and 220 is performed at a temperature ranging from about 400 degrees to about 600 degrees Celsius.

The space-dividing portions 224 of the second substrate 220 are cohered to the first substrate 210 due to a pressure difference between an inner space and an outer space of the lamp body 240.

Particularly, when the first and second substrates 210 and 220 are coupled to each other and the air in the light emitting spaces 230 is vented, the light emitting spaces 230 of the lamp body 240 maintain inner spaces thereof in a vacuum state. Various discharge gases are injected into the light emitting spaces 230 for the plasma discharge. In the present embodiment, the discharge gas may include mercury (Hg), neon (Ne), argon (Ar), and so on. In the present embodiment, a gas pressure of the light emitting spaces 230 is maintained in a range of about 50 Torr to about 70 Torr lower than an atmospheric pressure of about 760 Torr. Due to a pressure difference between the gas pressure of the light emitting spaces 230 and the atmospheric pressure, force is applied to the lamp body 240 toward the light emitting spaces 230, so that the space-dividing portions 224 may be cohered to the first substrate 210. Thus, the light emitting spaces 230 are separated from each other and do not communicate with each other except through the connection paths 240.

The lamp body 240 further includes a first fluorescent layer 270 and a second fluorescent layer 280. The first and second fluorescent layers 270 and 280 are formed on the first and second substrates 210 and 220, respectively, and between the first and second substrates 210 and 220 such that the first and second fluorescent layers 270 and 280 may face each other. The first and second fluorescent layers 270 and 280 are excited by the ultraviolet lights caused by the plasma discharge in the light emitting spaces 230 to emit the visible lights.

The lamp body 240 further includes a reflecting layer 290 formed between the first substrate 210 and the first fluorescent layer 270. The reflecting layer 290 reflects the visible lights emitted from the first and second fluorescent layers 270 and 280, thereby preventing the visible lights from being leaked through the first substrate 210. Thus, the visible lights may only exit the lamp body 240 through the second substrate 220. In order to enhance reflectance and reduce variation of color coordinates, the reflecting layer 290 includes a metal oxide material such as, but not limited to, aluminum oxide (Al₂O₃), barium sulfate (BaSO₄), or the like.

The first fluorescent layer 270, the second fluorescent layer 280, and the reflecting layer 290 are sprayed onto the first and second substrates 210 and 220 before combining the first substrate 210 with the second substrate 220. The first fluorescent layer 270, the second fluorescent layer 280, and the reflecting layer 290 are formed over the first and second substrates 210 and 220 except an area on which the sealing portion 226 is formed. Alternatively, the first fluorescent layer 270, the second fluorescent layer 280, and the reflecting layer 290 may not be formed on areas corresponding to the space-dividing portions 224.

Although not shown in FIGS. 6 and 7, the lamp body 240 may further include a passivation layer formed between the first substrate 210 and the reflecting layer 290 and/or between the second substrate 220 and the second fluorescent layer 280. The passivation layer prevents a chemical reaction between the first and second substrates 210 and 220 and the discharge gas such as the mercury (Hg), thereby preventing a loss of the mercury and darkening of the lamp body 240.

The electrode 250 is formed at second and fourth ends of the lamp body 240 in a substantially perpendicular direction to a longitudinal direction of the light emitting spaces 230, so that the electrode 250 is overlapped with all light emitting spaces 230. The electrode 250 is formed on at least one of the outer faces of the first substrate 210 and the second substrate 220. When the electrode 250 is formed on both outer faces of the first and second substrates 210 and 220, the first and second substrates 210 and 220 may be electrically connected to each other by means of a connection member such as a clip (not shown). Alternatively, the electrode 250 may be formed at inner faces of the first substrate 210 and the second substrate 220.

The electrode 250 is formed by coating silver (Ag) paste having silver (Ag) and silicon oxide (SiO₂). The electrode 250 may instead be formed by spraying metal powder having at least one conductive material, such as, for example, a metal or a metal composition. Although not shown in FIGS. 6 and 7, the lamp body 240 may further include an insulating layer formed on an outer face of the electrode 250 to protect the electrode 250.

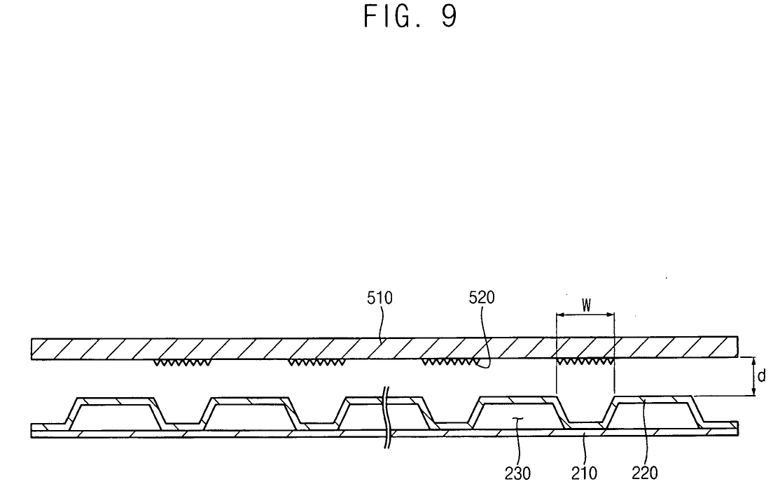

FIG. 8 is an exploded perspective view showing another exemplary embodiment of a backlight assembly according to the present invention. FIG. 9 is a cross-sectional view of an exemplary flat-type fluorescent lamp and an exemplary diffusion plate shown in FIG. 8.

Referring to FIGS. 8 and 9, a backlight assembly 500 includes a receiving container 110, a flat-type fluorescent lamp 200, a diffusion plate 510, and an inverter 120. In FIGS. 8 and 9, the same reference numerals denote same elements as previously described with respect to FIGS. 1 and 2, and thus any further detailed descriptions of the same elements will be omitted.

The diffusion plate 510 is disposed on the flat-type fluorescent lamp 200. A lower face of the diffusion plate 510 faces the flat-type fluorescent lamp 200, while an upper surface of the diffusion plate 510 faces an LCD panel. The diffusion plate 510 diffuses the lights from the flat-type fluorescent lamp 200 to improve the brightness uniformity of the lights. The diffusion plate 510 includes a transparent material and a light diffusing agent for the lights.

The diffusion plate 510 includes the prism pattern 520 formed on areas corresponding to areas between the light emitting spaces 230. In other words, the prism pattern 520 is located on areas of a lower surface of the diffusion plate 510 aligned with the space dividing portions of the flat-type fluorescent lamp 200. Other areas of the lower surface of the diffusion plate 510 not having the prism patterns 520 are prism absent portions. In the present embodiment, the prism pattern 520 has a width (W) of about 6 mm corresponding to the areas between the light emitting spaces 230. The prism pattern 520 reflects the lights toward a substantially vertical direction with respect to the diffusion plate 510, which are incident into side faces thereof from the light emitting spaces 230. Thus, the prism pattern 520 changes paths of the lights from the light emitting spaces 230, thereby reducing the dark line and improving brightness uniformity.

In the present embodiment, the prism pattern 520 has a same shape as those embodiments described in FIGS. 3 to 5, so that any further detailed description of the prism pattern 520 will be omitted. The prism pattern 520 is disposed on a lower surface of the diffusion plate 510 instead of the lower surface of a base film 310 of an optical member 300 as in the prior embodiments. The prism pattern 520 includes a transparent material such as polycarbonate (“PC”), polyethylene terephthalate (“PET”), polymethyl methacrylate (“PMMA”) or the like to prevent a light loss while the lights passes through the prism pattern 520. In the present embodiment, the prism pattern 520 may include a same material as or a different material from the diffusion plate 510. The prism pattern 520 may be formed on a lower face of the diffusion plate 510 using various manners such as stamping, extrusion molding, injection molding, etc.

The diffusion plate 510 is disposed on the flat-type fluorescent lamp 200 and spaced apart from an upper face of the flat-type fluorescent lamp 200 by a predetermined distance (d), where the distance (d) is measured from a portion of the second substrate 220 disposed furthest from the first substrate 210 of the flat-type fluorescent lamp 200. The predetermined distance (d) between the diffusion plate 510 and the flat-type fluorescent lamp 200 depends upon the shape of the prism pattern 520, or is below about 10 mm. In the present embodiment, the diffusion plate 510 is spaced apart from the flat-type fluorescent lamp 200 by a distance (d) from about 2 mm to about 4 mm, thereby remarkably reducing a thickness of the backlight assembly 100. Although not shown in FIGS. 8 and 9, in order to improve brightness characteristics of the lights, the backlight assembly 500 may further include various optical sheets disposed on the diffusion plate 510, such as, for example, a diffusion sheet, a prism sheet, and so on.

Hereinafter, a method of manufacturing the backlight assembly will be described with reference to FIGS. 1 and 2.

In order to manufacture the backlight assembly 100, the flat-type fluorescent lamp 200 is received into the receiving container 110. The optical member 300 is disposed on the flat-type fluorescent lamp 200, and then the inverter 120 is coupled to the receiving container 110.

The flat-type fluorescent lamp 200 received into the receiving container 110 is divided into the light emitting spaces 230 so as to emit the lights in response to the voltage applied from the inverter 120 to the electrodes 250.

The optical member 300 disposed on the flat-type fluorescent lamp 200 includes the prism pattern 320 formed at areas corresponding to areas between the light emitting spaces 230. The prism pattern 320 changes the paths of the lights toward the substantially vertical, perpendicular direction, which are incident at a non-perpendicular angle with respect to the optical member 300 into side faces thereof from the light emitting spaces 230, thereby reducing the dark line visible on an LCD panel and improving the brightness uniformity. The prism pattern 320 may be formed on the lower face of the base film 310 using various manners such as stamping, extrusion molding, injection molding, and so on. The prism pattern 320 may have any of the shapes described with respect to FIGS. 3, 4, and 5, and thus any further detailed descriptions of the prism pattern 320 will be omitted.

The inverter 120 coupled to the receiving container 110 generates the voltage and applies the generated voltage to the electrodes 250 of the flat-type fluorescent lamp 200.

In the method of manufacturing the backlight assembly 100, the diffusion plate 130 may be further disposed on the optical member 300. The diffusion plate 130 disposed on the optical member 300 diffuses the lights from the optical member 300 to improve the brightness uniformity.

Also, the optical member 300 may be further coupled to the lower face of the diffusion plate 130. When the optical member 300 is coupled to the lower face of the diffusion plate 130, deformation of the optical member 300 may be prevented and the optical member 300 may be stably received in the receiving container 110.

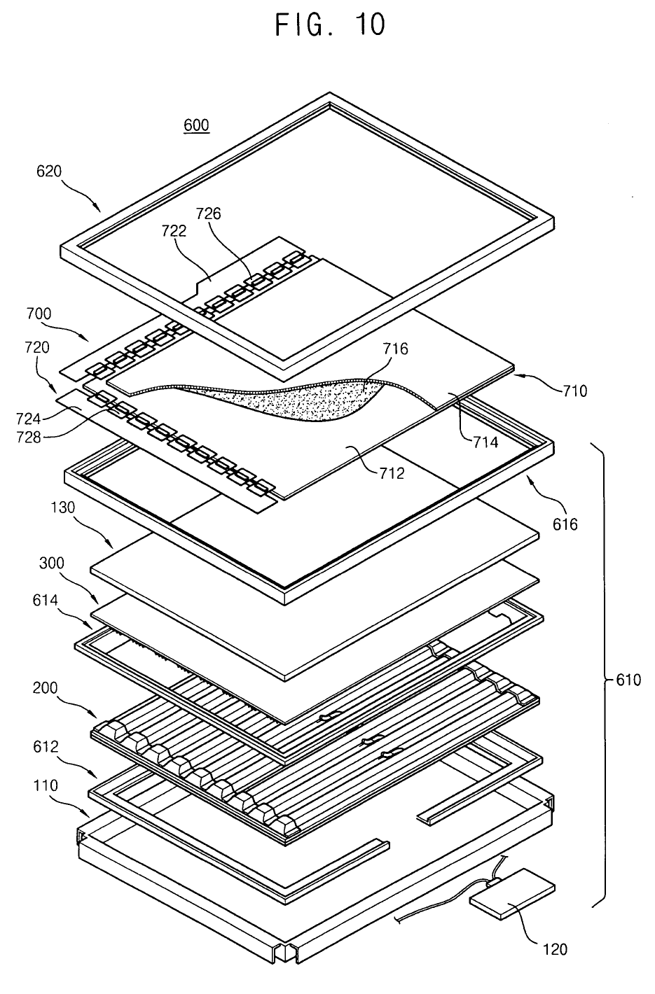

FIG. 10 is an exploded perspective view showing an exemplary embodiment of an LCD apparatus according to the present invention.

Referring to FIG. 10, an LCD apparatus 600 includes a backlight assembly 610 and a display unit 700.

In the present embodiment, the backlight assembly 610 includes a receiving container 110, a flat-type fluorescent lamp 200, an optical member 300, an inverter 120, and a diffusion plate 130 which have the same function and structure as those of the backlight assembly 100 shown in FIGS. 1 to 7. However, the backlight assembly 610 of the present embodiment may instead include a receiving container 110, a flat-type fluorescent lamp 200, an inverter 120, and a diffusion plate 510 which have the same function and structure as those of the backlight assembly 500 shown in FIGS. 8 to 9. Thus, any further detailed descriptions of the same elements will be omitted.

The backlight assembly 610 may further include a buffer member 612 disposed between the receiving container 110 and the flat-type fluorescent lamp 200 to support the flat-type fluorescent lamp 200 therein. The buffer member 612 is disposed on an end of the flat-type fluorescent lamp 200, such as at peripheral portions thereof. The buffer member 612 spaces the flat-type fluorescent lamp 200 apart from the receiving container 110 by a predetermined distance such that the flat-type fluorescent lamp 200 is not electrically connected to the receiving container 110, which may be made of metal. In order to electrically insulate the flat-type fluorescent lamp 200 from the receiving container 110, the buffer member 612 includes an insulating material. Also, the buffer member 612 has an elastic material such as silicon so as to absorb an impact externally applied to the flat-type fluorescent lamp 200, thus protecting the flat-type fluorescent lamp 200 from breakage. In the illustrated embodiment, the buffer member 612 includes two pieces each having a substantially U-shaped shape. However, the buffer member 612 may instead include four pieces corresponding to sides or corners of the flat-type fluorescent lamp 200, respectively. In yet another alternative embodiment, the four pieces of the buffer member 612 may be integrally formed into one piece.

The backlight assembly 610 may further include a first mold 614 disposed between the flat-type fluorescent lamp 200 and the optical member 300. The first mold 614 holds the end of the flat-type fluorescent lamp 200 and substantially simultaneously supports ends of the optical member 300 and the 1o diffusion plate 130. In the illustrated embodiment, the first mold 614 has a frame shape. Alternatively, the first mold 614 may have two pieces each having a substantially U-shaped shape or a substantially L-shaped shape, or four pieces corresponding to sides of the flat-type fluorescent lamp 200, respectively.

The backlight assembly 610 may further a second mold 616 disposed between the diffusion plate 130 and the display unit 700. The second mold 616 holds ends of the optical member 300 and the diffusion plate 130 and substantially simultaneously supports ends of the LCD panel 710. In the illustrated embodiment, the second mold 616 also has the frame shape, however, the second mold 616 may instead be formed of two pieces or four pieces.

The display unit 700 includes an LCD panel 710 that displays an image using a light from the backlight assembly 610 and a driving circuit 720 that drives the LCD panel 710.

The LCD panel 710 includes a first substrate 712, a second substrate 714 facing the first substrate 712, and a liquid crystal layer 716 disposed between the first and second substrates 712 and 714.

The first substrate 712 is a TFT substrate on which TFTs are formed in a matrix configuration. The first substrate 712 includes glass. Each of the TFTs has a source connected to a data line, a gate connected to a gate line, and a drain connected to a pixel electrode (not shown) that is a transparent and conductive material.

The second substrate 714 is a color filter substrate on which red, green, and blue (“RGB”) pixels (not shown) are formed by a thin film process. The second substrate 714 also includes glass. The second substrate 714 includes a common electrode (not shown) formed thereon. The common electrode includes a transparent conductive material.

When a power is applied to the gate of the TFT and the TFT is turned on, an electric field is generated between the pixel electrode and the common electrode. The electric field varies an aligning angle of the liquid crystal molecules within the liquid crystal layer 716 interposed between the first substrate 712 and the second substrate 714. Thus, a light transmittance of the liquid crystal layer 716 is varied in accordance with the variation of the aligning angle of the liquid crystal, so a desired image may be obtained.

The driving circuit 720 includes a data printed circuit board (“PCB”) 722 that applies a data driving signal to the LCD panel 710, a gate PCB 724 that applies a gate driving signal to the LCD panel 710, a data flexible printed circuit (“FPC”) film 726 that electrically connects the data PCB 722 to the LCD panel 710 and a gate FPC film 728 that electrically connects the gate PCB 724 to the LCD panel 710. The data and gate FPC films 726 and 728 include a tape carrier package (“TCP”) or a chip-on-film (“COF”). When separated signal lines are formed on the LCD panel 710 and the gate FPC film 728, the gate PCB 724 may be removed.

The LCD apparatus 600 further includes a top chassis 620 so as to fix the display unit 700 to the backlight assembly 610. The top chassis 620 is coupled to the receiving container 110 to fix ends, such as the periphery, of the LCD panel 710 to the backlight assembly 610. The data PCB 722 is bent by means of the data FPC film 726 such that the data PCB 722 is fixed to a side portion of a rear portion of the receiving container 110. The top chassis 620 includes a metal having a superior strength.

According to the backlight assembly, the manufacturing method of the backlight assembly, and the LCD apparatus, the backlight assembly includes the optical member having the prism pattern formed at areas corresponding to areas between the light emitting spaces or the diffusion plate having the prism pattern formed on the lower face thereof, so that the backlight assembly may improve the brightness uniformity.

Also, the backlight assembly may have a reduced thickness since the distance between the optical member or the diffusion plate and the flat-type fluorescent lamp can be reduced.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A backlight assembly comprising:
a receiving container having a receiving space;
a flat-type light source having a plurality of light emitting spaces spaced apart from each other, the flat-type light source received within the receiving space;
an optical member having a prism pattern formed in areas corresponding to areas between adjacent light emitting spaces, the optical member disposed at a light emitting direction of the flat-type light source; and
an inverter generating a voltage for the flat-type light source.

2. The backlight assembly of claim 1, wherein the prism pattern of the optical member includes a plurality of prisms each having at least two faces and the plurality of prisms are interconnected to each other.

3. The backlight assembly of claim 2, wherein the optical member comprises a prism absent portion.

4. The backlight assembly of claim 3, wherein each of the prisms comprises a first inclined face and a second inclined face elongated from a light receiving face of the optical member.

5. The backlight assembly of claim 4, wherein the prisms each comprise a same internal angle between the first inclined face and the second inclined face of each prism.

6. The backlight assembly of claim 5, wherein the internal angle is about 60 degrees.

7. The backlight assembly of claim 4, wherein the internal angle between the first and second inclined faces increases as the prisms are spaced further apart from a center portion of the prism pattern.

8. The backlight assembly of claim 4, wherein the internal angle between the first and second inclined faces decreases as the prisms are spaced further apart from a center portion of the prism pattern.

9. The backlight assembly of claim 4, wherein the prisms each comprise a rounded corner where the first inclined face meets the second inclined face.

10. The backlight assembly of claim 4, wherein an internal angle between the first inclined face and the second inclined face of each prism is selected to change an angle of a non-perpendicular incident light ray into a perpendicular light ray with respect to a light exiting surface of the optical member.

11. The backlight assembly of claim 1, wherein the flat-type light source comprises:
a lamp body in which the light emitting spaces are formed; and
an electrode formed at opposite ends of the lamp body and intersected with each of the light emitting spaces.

12. The backlight assembly of claim 11, wherein the lamp body comprises:
a first substrate; and
a second substrate coupled to the first substrate, the first and second substrates forming the light emitting spaces, the second substrate comprising:
light emitting space portions spaced apart from the first substrate forming the light emitting spaces;
space-dividing portions coupled to the first substrate and disposed between the light emitting space portions, respectively; and
a sealing portion formed on an end of the second substrate and combined with the first substrate.

13. The backlight assembly of claim 12, wherein the sealing portion extends along a periphery of the second substrate, and the sealing portion of the second substrate is combined with the first substrate with a frit.

14. The backlight assembly of claim 12, wherein the prism pattern corresponds to the space-dividing portions.

15. The backlight assembly of claim 12, wherein areas of the optical member facing the light source and corresponding to the light emitting spaces are absent a prism pattern.

16. The backlight assembly of claim 1, wherein the flat-type light source is spaced apart from the optical member by a range from about 2 mm to about 4 mm.

17. The backlight assembly of claim 1, further comprising a diffusion plate diffusing the light, the diffusion plate disposed on the optical member.

18. The backlight assembly of claim 17, wherein the optical member is coupled to a lower face of the diffusion plate.

19. The backlight assembly of claim 18, wherein the optical member includes a base film having an upper surface coupled to the lower face of the diffusion plate and a lower surface having the prism pattern.

20. The backlight assembly of claim 1, wherein the prism pattern extends lengthwise in a same longitudinal direction as a lengthwise direction of the light emitting spaces.

21. The backlight assembly of claim 1, wherein the prism pattern changes an angle of a non-perpendicular incident light ray into a perpendicular light ray with respect to a light exiting surface of the optical member.

22. A backlight assembly comprising:
a receiving container providing a receiving space;
a flat-type light source having a plurality of light emitting spaces spaced apart from each other and emitting a light, the flat-type light source received within the receiving space;
a diffusion plate having a prism pattern formed in areas corresponding to areas between adjacent light emitting spaces, the diffusion plate disposed on the flat-type light source; and
an inverter generating a voltage for the flat-type light source.

23. The backlight assembly of claim 22, wherein the prism pattern comprises prisms having a substantially trigonal shape and continuously connected one after another, and
each of the prisms comprises a first inclined face and a second inclined face elongated from a lower face of the diffusion plate.

24. The backlight assembly of claim 23, wherein the prisms each comprise a same internal angle between the first inclined face and the second inclined face of each prism.

25. The backlight assembly of claim 23, wherein an internal angle between the first and second inclined faces increases as the prisms are spaced further apart from a center portion of the prism pattern.

26. The backlight assembly of claim 22, wherein the flat-type light source is spaced apart from the diffusion plate by a range from about 2 mm to about 4 mm.

27. A method of manufacturing a backlight assembly comprising:
receiving a flat-type light source having a plurality of light emitting spaces spaced apart from each other and emitting a light into a receiving container;
disposing an optical member having a prism pattern formed in areas corresponding to areas between adjacent light emitting spaces on the flat-type light source; and
coupling an inverter to the receiving container, the inverter generating a voltage for the flat-type light source.

28. The method of claim 27, wherein the prism pattern comprises prisms each having a substantially trigonal shape and continuously connected one after another, and
each of the prisms comprises a first inclined face and a second inclined face elongated from a lower face of the optical member.

29. The method of claim 28, wherein the prisms each comprise a same internal angle between the first inclined face and the second inclined face of each prism.

30. The method of claim 28, wherein an internal angle between the first and second inclined faces increases as the prisms are spaced further apart from a center portion of the prism pattern.

31. The method of claim 27, wherein disposing an optical member on the flat-type light source includes spacing the optical member by a range from about 2 mm to about 4 mm from the flat-type light source.

32. The method of claim 27, further comprising disposing a diffusion plate on the optical member.

33. The method of claim 32, further comprising coupling the optical member to the diffusion plate.

34. A liquid crystal display apparatus comprising:
a receiving container having a receiving space;
a flat-type light source having a plurality of light emitting spaces spaced apart from each other and emitting a light, the flat-type light source received within the receiving space;
an optical member having a prism pattern formed in areas corresponding to areas between adjacent light emitting spaces, the optical member disposed on the flat-type light source;
a backlight assembly having an inverter generating a voltage for the flat-type light source; and
a display unit displaying an image using the light emitted from the backlight assembly.

35. The liquid crystal display apparatus of claim 34, wherein the prism pattern comprises prisms having a substantially trigonal shape and continuously connected one after another.

36. The liquid crystal display apparatus of claim 35, wherein each of the prisms comprises a first inclined face and a second inclined face elongated from a lower face of the optical member, and
each of the prisms comprises a same internal angle between the first inclined face and the second inclined face.

37. The liquid crystal display apparatus of claim 35, wherein the display unit comprises:
a liquid crystal display panel displaying an image; and
a driving circuit generating a driving signal for the liquid crystal display panel.
